(19) United States
(12) Patent Application Publication
(10) Pub. No.: US 2013/0164469 A1
(43) Pub. Date: Jun. 27, 2013

(54) OUTDOOR COVERING DEVICE

(71) Applicant: Thomas J. Artmann, Mequon, WI (US)

(72) Inventor: Thomas J. Artmann, Mequon, WI (US)

(21) Appl. No.: 13/335,149

(22) Filed: Dec. 22, 2011

(51) Int. Cl. B44F 9/00; B44C 5/06

(52) U.S. Cl. 428/35.2; 53/469

(57) ABSTRACT

A landscaping cover adapted to camouflage undesirable yard objects is provided. The landscaping cover includes a top edge, a bottom edge, a flexible sidewall, an interior cavity and an opening. The flexible sidewall extends between the top edge and the bottom edge and includes an inner surface and an outer surface. The interior cavity is defined by the inner surface of the sidewall and is configured to receive the yard object within the interior cavity. The opening to the interior cavity is defined by the bottom edge.

### BACKGROUND OF THE INVENTION

The application generally relates to landscaping covers. More specifically, the application relates to landscaping covers that have a flexible sidewall.

### SUMMARY OF THE INVENTION

One embodiment of the invention relates to a camouflaged yard object. The camouflage yard object includes a yard object and a cover. The yard object has an external surface. The cover includes a top edge, a bottom edge, a flexible sidewall, an interior cavity and an opening. The flexible sidewall extends between the top edge and the bottom edge and includes an inner surface and an outer surface. The interior cavity is defined by the inner surface of the sidewall and is configured to receive the yard object within the interior cavity. The opening to the interior cavity is defined by the bottom edge.

Another embodiment of the invention relates to a landscaping cover adapted to camouflage undesirable yard objects. The landscaping cover includes a top edge, a bottom edge, a flexible sidewall, an interior cavity, a fastener and an opening. The flexible sidewall extends between the top edge and the bottom edge and includes an inner surface and an outer surface. The flexible sidewall has a camouflaging pattern on the outer surface. The interior cavity is defined by the inner surface of the sidewall and is configured to receive the yard object within the interior cavity. The fastener is coupled to the sidewall. The fastener is configured to constrict the inner surface of the sidewall into engagement with the external surface of the yard object such that the cover is secured to the yard object. The landscaping cover includes an opening to the interior cavity is defined by the bottom edge.

Another embodiment of the invention relates to a method for concealing an outdoor yard object with a cover. The method includes selling a landscaping cover. The cover includes a top edge, a bottom edge and a flexible sidewall extending between the top edge and the bottom edge. The sidewall includes an inner surface and an outer surface. The cover includes an interior cavity defined by the inner surface of the sidewall, and the cover is configured to receive the yard object within the interior cavity. The cavity includes an opening to the interior cavity defined by the bottom edge. The method further includes providing an indicia with the landscaping cover, and the indicia is representative of instructions for placing the cover over the yard object by inserting the yard object through the opening into the interior cavity such that the inner surface of the sidewall contacts an external surface of the yard object and securing the cover in place relative to the yard object.

Another embodiment of the invention relates to a method for concealing an outdoor yard object with a cover. The method for concealing an outdoor yard object with a cover includes providing a cover, placing the cover over the yard object, moving the cover along the length of the yard object and fixing the cover in place relative to the yard object. The cover includes a top edge, a bottom edge, a flexible sidewall, an interior cavity and an opening. The flexible sidewall extends between the top edge and the bottom edge and includes an inner surface and an outer surface. The interior cavity is defined by the inner surface of the sidewall and is configured to receive the yard object within the interior cavity. The opening to the interior cavity is defined by the bottom edge. The cover is placed over the yard object by inserting the yard object through the opening into the interior cavity such that the inner surface of the sidewall contacts the external surface of the yard object. The cover is moved along the length of the yard object to bring the bottom edge of the cover adjacent to a bottom edge of the yard object such that substantially all of the yard object is concealed by the cover.

In various embodiments, the flexible sidewall includes a camouflage pattern that is configured to visually blend the sidewall into the surroundings thereby making the cover and yard object less noticeable. In one embodiment, the sidewall is a single camouflaging color. In another embodiment, the flexible sidewall includes a mottled, camouflage pattern. In some such embodiments, the mottled, camouflage pattern and/or the solid camouflaging color is colored to visually blend the sidewall into the structures, objects, landscaping, etc. adjacent to the yard object.

Alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein the like reference numerals refer to like elements in which:

FIG. 1 is a perspective view of a landscaping cover according to the exemplary embodiment;

FIG. 2 is a view showing the landscaping cover configured to receive the yard object within the interior cavity;

FIG. 3 is a view showing the landscaping cover partially concealing the yard object;

FIG. 4 is a view showing the landscaping cover fixed in place relative to the yard object to camouflage the yard object into the surrounding landscape;

FIG. 5 is a perspective view of a landscaping cover being used to camouflage a yard object according to another exemplary embodiment;

FIG. 6 is a perspective view of a landscaping cover being used to camouflage a yard object according to another exemplary embodiment; and

FIG. 7 is a flow chart of a method of selling a landscaping cover according to the exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

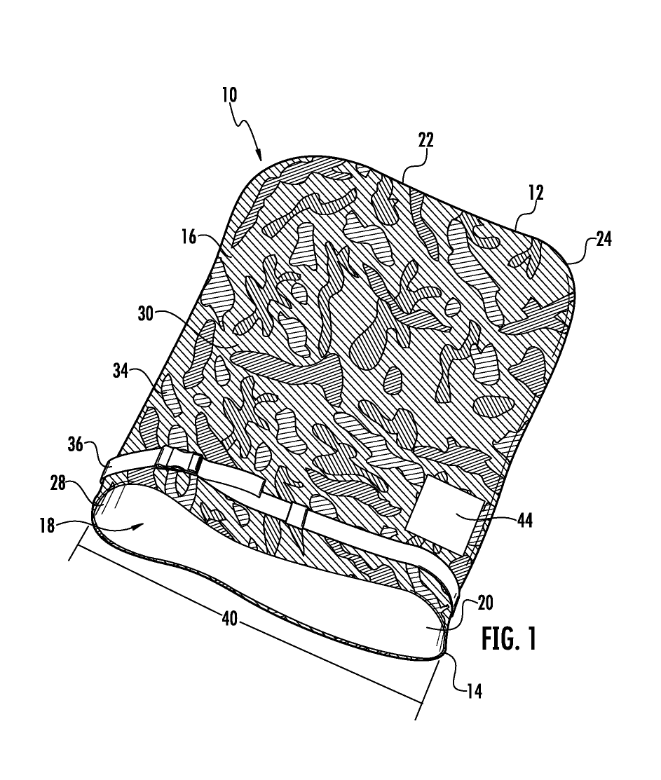

Referring to FIG. 1, a landscaping cover 10 fabricated all, or in part, of a flexible material (such as a cloth material) is shown. In the embodiment shown in FIG. 1, the landscaping cover 10 is used to conceal undesirable yard objects by blending yard objects into the surrounding landscape. Landscaping covers, such as the landscaping cover 10, are shaped and configured to be placed over various yard objects to conceal yard objects with different dimensions, sizes and configurations, such as septic vent pipes, utility boxes, sump pump pipes, power outlets, well heads, satellite dishes, water pumps, sprinkler heads, etc. In various embodiments, landscaping covers made from a flexible material act to conceal yard objects in a landscape by camouflaging the yard object by blending the covered yard object into its surroundings.

In various embodiments, the cloth material that the landscaping cover 10 is made from may be manufactured from any flexible woven material or material that includes interlaced fibers. The cloth material may include a network of natural and/or synthetic fibers or filaments, such as wool, flax, cotton, nylon, polyester or any other material that produces long strands. The cloth material may be formed by a variety of methods, such as weaving, knitting, knotting, crocheting or pressing fibers together (e.g., felting). The cloth material may also be weather resistant and UV resistant in order to withstand external environmental factors more effectively, such as various types of precipitation, wind, sun, etc.

Still referring to FIG. 1, the cloth material also includes a camouflage pattern 34. A camouflage pattern is a color, pattern shape, and/or a combination of colors and pattern shapes that act to make a covered yard object less noticeable by blending in with the yard object's surroundings. In various embodiments, camouflage pattern 34 is a mottled camouflage pattern. A variety of camouflage patterns may be used to conceal yard objects depending upon the surroundings (e.g., surrounding landscapes, structures, buildings, etc.) of the yard objects. As a first example, yard objects located in snowy landscapes may use the landscaping cover 10 that is mottled with various shades of white, grey and black. As a second example, yard objects located in woody or arborous landscapes may use the landscaping cover 10 mottled with various shades of brown, green, black and yellow. As a third example, yard objects located in desert-like landscapes may use the landscaping cover 10 that is mottled with various shades of yellow, white, black and brown. As a fourth example, yard objects located in grass or lawn landscapes may use the landscaping cover 10 that is mottled with various shades of green, black, yellow and brown.

In other embodiments, the camouflage pattern 34 is a single color selected to camouflage relative to the surrounding area. As one example, yard objects located in grass or lawn landscapes may be camouflaged with the landscaping cover 10 that is a single or solid color of an appropriate green hue. As another embodiment, yard objects located in a snowy landscape may be camouflaged with a landscaping cover 10 that is a solid white or grey color. In addition to the solid and various mottled patterns, the camouflage pattern 34 may also include one or more elements depicting objects present in the surrounding landscape such as leaves, grass, twigs, tree bark, etc., to further blend yard objects into a surrounding landscape.

Referring to FIG. 1 again, the landscaping cover 10 includes a top edge 12, a bottom edge 14, a flexible sidewall 16, an interior cavity 18 and an opening 20. The landscaping cover 10 is fabricated using a cloth material with the mottled, camouflaging pattern 34 that is capable of concealing yard objects by being placed over various yard objects and blending the covered yard objects into the surrounding landscape. When the landscaping cover 10 is being used, it will be difficult for a person to differentiate the covered yard object from the surrounding landscape.

Referring to FIG. 1, the flexible sidewall 16 extends the length between the top edge 12 and the bottom edge 14. The flexible sidewall 16 also includes an inner surface 28 and an outer surface 30. The inner surface 28 of the flexible sidewall 16 defines the interior cavity 18. The outer surface 30 is adjoined to the inner surface 28 throughout the entire landscaping cover 10. The outer surface 30 includes the camouflage pattern 34 that blends the landscaping cover 10 into a surrounding landscape and is directly exposed to external environmental factors. The flexible sidewall 16 of the exemplary embodiment is constructed with the same cloth material throughout the entire length between the top edge 12 and the bottom edge 14. In the exemplary embodiment, the inner surface 28 is also constructed of the same cloth material as the outer surface 30. In alternative embodiments, the flexible sidewall 16 may be constructed with different types of cloth material or differing camouflage patterns between the top edge 12 and the bottom edge 14. For example, in one embodiment, a first portion of the landscaping cover 10 (e.g., the upper portion) includes a first pattern that acts as camouflage relative to the surroundings of the upper portion of the yard object, and a second portion of the landscaping cover 10 (e.g., the lower portion) includes a second pattern that acts as camouflage relative to the surroundings of the lower portion of the yard object. In alternative embodiments, the inner surface 28 and the outer surface 30 may also be constructed of different types of cloth material or differing camouflage patterns. For example in one embodiment, the landscaping cover 10 includes an outer layer of material that defines the outer surface 30 made from a camouflaged patterned cloth material and an inner layer of material that defines the inner surface 28 made from a slick or low friction material (e.g., nylon) that assists in placement of the landscaping cover 10 over the yard object.

Still referring to FIG. 1, the flexible sidewall 16 extends upward, towards the top edge 12 and is coupled to a top wall 22 that has a peripheral edge 24. In the exemplary embodiment, the peripheral edge 24 of the top wall 22 and the top edge 12 of the flexible sidewall 16 form a seam around the entire periphery of the top wall 22 when coupled to each other. The seam may be formed using stitches, an adhesive, ultrasonic weld, a sealant or other method that is capable of coupling the top wall 22 and the flexible sidewall 16 to each other. In alternative embodiments, the seam may not extend around the entire periphery of the top wall 22, creating an access point or opening along the peripheral edge 24 to provide a user with access to the top of the interior cavity 18 and provides access to the top or upper portions of the covered yard object without requiring removal of the landscaping cover 10 from the yard object.

Referring to FIG. 1, the flexible sidewall 16 extends downward from top wall 22, towards the bottom edge 14. The flexible sidewall 16 also includes a fastener 36 that is coupled to the flexible sidewall 16 on the outer surface 30 between the top edge 12 and the bottom edge 14. In the embodiment shown in FIG. 1, the fastener 36 is coupled near the bottom edge 14. The outer surface 30 has a perimeter (e.g., a circumference). The bottom edge 14 defines the opening 20 to the interior cavity 18. The interior cavity 18 has a width 40 that extends between two points on the inner surface 28. The fastener 36 extends the entire length of the perimeter of the outer surface 30 and is configured to constrict the inner surface 28 of the flexible sidewall 16. The fastener 36 may be a buckle, strap, drawstring, a strip or section of loop and hook material or any other suitable fastening structure. Alternative embodiments may include fasteners that only extend a portion of the perimeter or include a different type of fastener, such as snaps, buttons, Velcro, belt, neckband and ratchet, zip tie arrangement or other fastener device that is capable of constricting the inner surface 28 of the flexible sidewall 16.

Still referring to FIG. 1, the landscaping cover 10 also includes an indicia 44 that is associated with the landscaping cover 10. In one embodiment, as shown in FIG. 1, the indicia 44 is coupled to the outer surface 30 of the flexible sidewall 16, and in one embodiment, the coupling between the indicia 44 and the flexible sidewall 16 is frangible or reversible such that the indicia 44 may be removed following application of the landscaping cover 10 to a yard object. In other embodiments, the indicia 44 is associated with the landscaping cover 10 in other ways. For example, the indicia 44 may be coupled to packaging for the landscaping cover 10 and/or may be located within packaging containing the landscaping cover 10. In this embodiment, the indicia 44 may be printed on a label or printed on to an information card or booklet associated with the landscaping cover 10.

Generally, the indicia 44 provides instructions regarding applying the landscaping cover 10 over a yard object to provide sufficient camouflaging. In one such embodiment, the indicia 44 represents the yard object being inserted through the opening 20 and securing the landscaping cover 10 in place relative to the yard object. The indicia 44 may use pictures only, pictures and text, text only, or any other method or combination to illustrate and/or describe how the landscaping cover 10 is placed over the yard object for concealment in various landscapes.

The exemplary embodiment includes the indicia 44 coupled to the outer surface 30 of the flexible sidewall 16. Alternative embodiments of the landscaping cover 10 may include additional indicia, for example, three indicia may be used in order to illustrate/describe the method for concealing yard objects by using the landscaping cover 10 in various landscapes. Alternative embodiments of the landscaping 10 may also have the indicia 44 coupled to the inner surface 28 of the flexible sidewall 16. In one such embodiment, the indicia 44 is coupled to the inner surface 28 of the flexible sidewall 16 adjacent to the bottom edge 14 such that the indicia 44 is moveable between a first or exposed position in which the indicia 44 extends out of the opening 20 and a second or internal position in which the indicia 44 is located within the interior cavity 18. In this embodiment, the surface of the indicia 44 is outward facing in the exposed position. This embodiment allows the indicia 44 to be viewed during installation of the landscaping cover 10, and also allows the indicia 44 to be hidden within the interior cavity 18 or removed entirely from the landscaping cover 10 following installation improving the camouflaging function of the landscaping cover 10.

In other embodiments that include more than one indicia, the indicia may be coupled to the flexible sidewall 16 in different locations. For example, two indicia may be coupled to the outer surface 30 of the flexible sidewall 16 and a third indicia may be coupled to the inner surface 28 of the flexible sidewall 16.

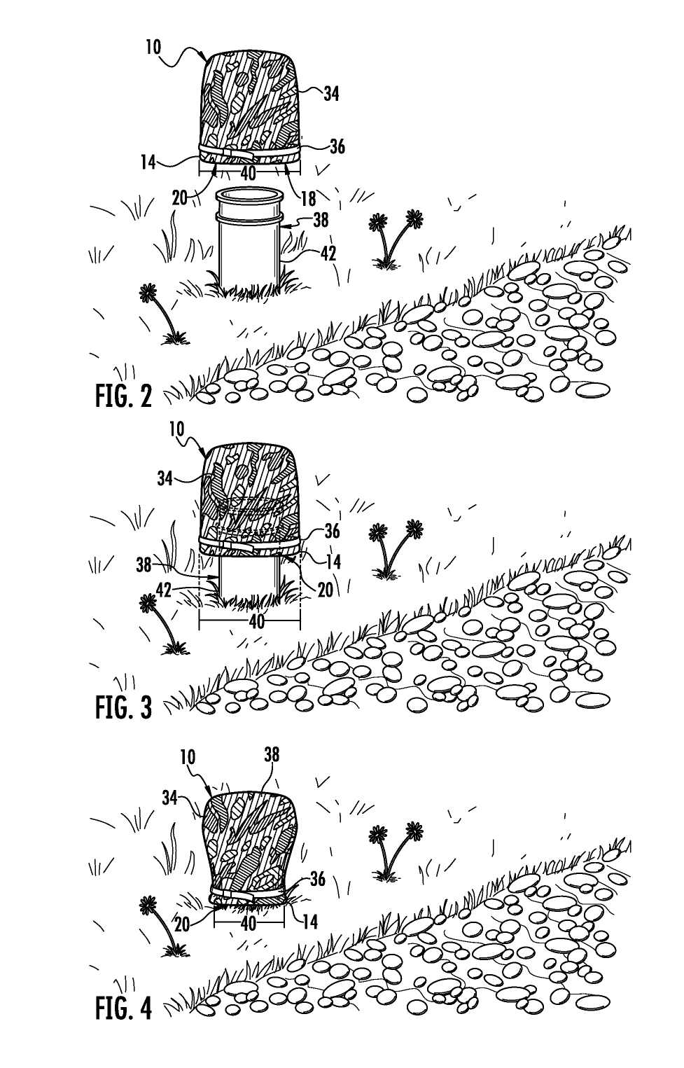

Referring to FIG. 2, FIG. 3 and FIG. 4, the landscaping cover 10 with the camouflage pattern 34 is placed over a yard object 38 extending from the ground to conceal the yard object 38 by visually blending the covered yard object 38 into the surrounding landscape. The interior cavity 18 of the landscaping cover 10 is configured to receive the yard object 38 within the interior cavity 18. The landscaping cover 10 is placed over the yard object 38 by inserting the yard object 38 through the opening 20 into the interior cavity 18. The inner surface 28 (shown in FIG. 1) of the flexible sidewall 16 faces an external surface 42 of the yard object 38. In one embodiment, when the yard object 38 is inserted into the interior cavity 18, at least a portion of the inner surface 28 contacts the external surface 42 of the yard object 38 providing a close or “form-fitting” fit of the landscaping cover 10 over the yard object 38. The landscaping cover 10 is then moved along the length of the yard object 38 so that the bottom edge 14 is adjacent to the bottom edge of the yard object 38 and that the bottom edge 14 is also adjacent to the ground, such that substantially all of the yard object 38 is concealed by the landscaping cover 10. The landscaping cover 10 is fixed into place with the yard object 38 when the bottom edge 14 is adjacent to the bottom edge of the yard object 38 with the fastener 36. The fastener 36 secures the landscaping cover 10 to the yard object 38 by constricting the inner surface 28 into engagement with the external surface 42 of the yard object 38. The width 40 of the interior cavity 18 and the perimeter of the outer surface 30 at the point where the fastener 36 is located decreases when the fastener 36 constricts the inner surface 28.

Referring to FIG. 4, the landscaping cover 10 with the camouflage pattern 34 appropriate for the surrounding landscape that is securely fastened to a yard object 38 will blend into the surrounding landscape, making it difficult for a person to differentiate between the covered yard object 38 and the rest of the surrounding landscape. For example, a septic vent pipe that protrudes out of the ground and is located in a snowy environment may use a landscaping cover 10 with a camouflage pattern 34 designed for snowy environments. More specifically, the camouflage pattern 34 designed for snowy surroundings may include various shades of white, black and grey. As another example, the septic vent pipe may protrude out of the ground located on a beach or another sandy or arid environment, and the landscaping cover 10 used to conceal the pipe may have a camouflage pattern 34 designed for such environment that includes various shades of white, yellow and brown. As another example, the septic vent pipe may protrude out of the ground located in a grassland or woodland environment, and the landscaping cover 10 used to conceal the pipe may have a camouflage pattern 34 designed for such environment that includes various shades of brown, green, yellow and black.

Generally, multiple landscaping covers 10 may be used within close proximity to each other (e.g., in a single yard) and may include more than one type of the landscaping cover 10 based upon the specific location of the yard objects 38 in a landscape. The camouflaging provided by the landscaping cover 10 may make the use of multiple landscaping covers more aesthetically pleasing and less obtrusive in a landscape, as compared to a landscape cover that merely hides a yard object. For example, there may be five yard objects in a landscape to be concealed with the landscaping cover 10. Two of the yard objects 38 located in a grassy environment may use the landscaping cover 10 that has the camouflage pattern 34 that is a solid shade of green. The remaining three yard objects that are located in a more arborous environment may use the landscaping cover 10 that has the camouflage pattern 34 that is mottled with shades of green, brown, black and yellow. Because the landscaping covers 10 makes the yard objects less noticeable by camouflaging the yard objects, the overall appearance of the yard may be enhanced by the lack of noticeable yard objects and the lack of noticeable landscape covers.

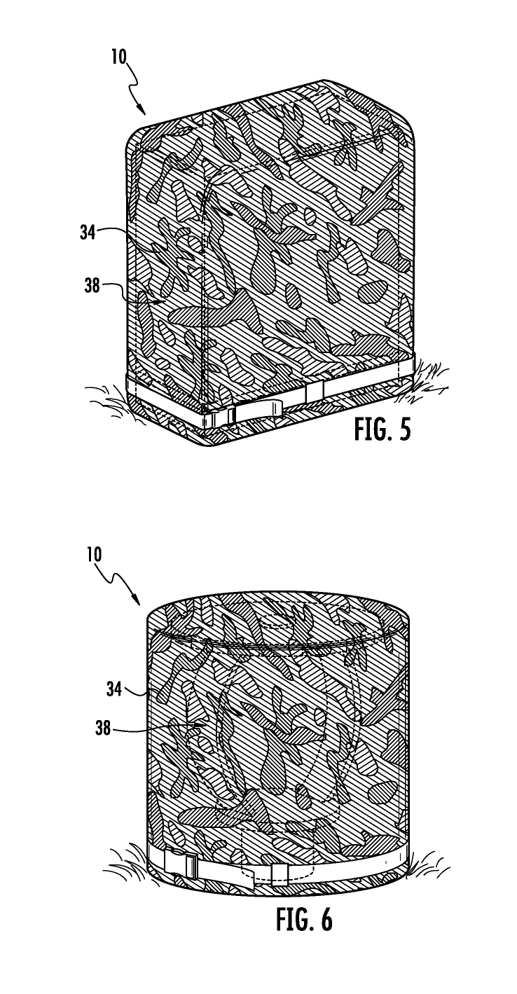

Referring to FIG. 5 and FIG. 6, the landscaping cover 10 with the camouflage pattern 34 may be used to cover and conceal different types of yard objects 38 with varying sizes and dimensions. In this embodiment, the flexible material of the landscaping cover 10 may be elastic such that the landscaping cover 10 expands (e.g., is stretched over) to fit yard objects 38 of varying sizes. In other embodiments, the landscaping cover 10 may be sized and/or shaped to match the shape of differently shaped yard objects 38. In these embodiments, the interior cavity 18 may have various dimensions in order to receive and conceal yard objects 38 of varying sizes and dimensions. For example, a larger landscaping cover 10 that is rectangular in shape may be placed over an electrical box to conceal and camouflage it into its surroundings. As another example, landscaping cover 10 is smaller and circular in shape to conceal a water sprinkler head in order to camouflage it into its surroundings.

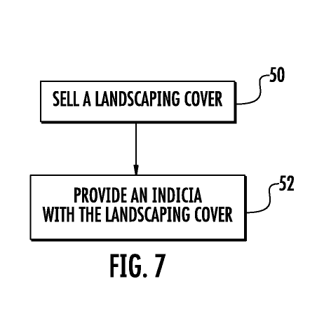

Referring to FIG. 7, a method for camouflaging a yard object is shown. In one embodiment, the landscaping cover 10 with the camouflaging pattern 34 that is placed over the yard object 38 extending from the ground to conceal the yard object 38 is sold (Step 50). The indicia 44 is provided (Step 52). As discussed above, the indicia 44 represents placing the landscaping cover 10 over the yard object by inserting the yard object 38 through the opening 20 into the interior cavity 18 such that the inner surface 28 of the flexible sidewall 16 contacts an external surface 42 of the yard object 38 and secures the landscaping cover 10 in place relative to the yard object 38.

Further modification and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

What is claimed is:

1. A camouflaged yard object comprising:
a yard object including an external surface;
a cover comprising;
a top edge;
a bottom edge;
a flexible sidewall extending between the top edge and the bottom edge, the sidewall including an inner surface and an outer surface;
an interior cavity defined by the inner surface of the sidewall, wherein the cover is configured to receive the yard object within the interior cavity; and
an opening to the interior cavity defined by the bottom edge.

2. The camouflaged yard object of claim 1, further comprising a top wall including a peripheral edge, wherein the peripheral edge of the top wall is coupled to the top edge of the sidewall.

3. The camouflaged yard object of claim 1, wherein the yard object is located in the interior cavity and a portion of the inner surface of the sidewall faces and is in contact with an external surface of the yard object when the cover is in use, and wherein the bottom edge of the cover is located adjacent to the bottom of the yard object, and further wherein the yard object extends from the ground and the bottom edge of the cover is adjacent to the ground.

4. The camouflaged yard object of claim 1, further comprising a fastener coupled to the sidewall, the fastener configured to constrict the inner surface of the sidewall into engagement with the external surface of the yard object such that the cover is secured to the yard object.

5. The camouflaged yard object of claim 4, wherein the fastener includes at least one of a buckle, a strap, a drawstring, and a loop and hook material.

6. The camouflaged yard object of claim 1, wherein the sidewall is formed from a cloth material.

7. The camouflaged yard object of claim 6, wherein the cloth material includes a camouflaged pattern, and further wherein the cloth material is weather resistant and UV resistant.

8. A landscaping cover adapted to camouflage undesirable yard objects comprising:
a top edge;
a bottom edge;
a flexible sidewall extending between the top edge and the bottom edge, the sidewall including an inner surface and an outer surface, the flexible sidewall having a camouflaging pattern on the outer surface;
an interior cavity defined by the inner surface of the sidewall, wherein the cover is configured to receive the yard object within the interior cavity;
a fastener coupled to the sidewall, the fastener configured to constrict the inner surface of the sidewall into engagement with the external surface of the yard object such that the cover is secured to the yard object; and
an opening to the interior cavity defined by the bottom edge.

9. The landscaping cover of claim 8, further comprising a top wall including a peripheral edge, wherein the peripheral edge of the top wall is coupled to the top edge of the sidewall.

10. The landscaping cover of claim 8, wherein the yard object is located in the interior cavity and the inner surface of the sidewall faces an external surface of the yard object when the cover is in use.

11. The landscaping cover of claim 8, further including a first indicia and a second indicia coupled to the sidewall, the first indicia representative of the yard object being inserted through opening, the second indicia representative of the cover being fixed in place relative to the yard object by the fastener.

12. The landscaping cover of claim 8, wherein the fastener includes at least one of a buckle, a strap, a drawstring, and a loop and hook material.

13. The landscaping cover of claim 8, wherein the sidewall is formed from a cloth material.

14. The landscaping cover of claim 13, wherein the cloth material includes a camouflage pattern.

15. The landscaping cover of claim 14, wherein the cloth material is weather resistant and UV resistant.

16. A method for concealing an outdoor yard object with a cover comprising:
selling a landscaping cover, the cover comprising:
a top edge;
a bottom edge;
a flexible sidewall extending between the top edge and the bottom edge, the sidewall including an inner surface and an outer surface;
an interior cavity defined by the inner surface of the sidewall, wherein the cover is configured to receive the yard object within the interior cavity; and
an opening to the interior cavity defined by the bottom edge;
providing an indicia with the landscaping cover, the indicia representative of instructions for placing the cover over the yard object by inserting the yard object through the opening into the interior cavity such that the inner surface of the sidewall contacts an external surface of the yard object, and securing the cover in place relative to the yard object.

17. The method of claim 16, wherein the landscaping cover further comprises a top wall including a peripheral edge, wherein the peripheral edge of the top wall is coupled to the top edge of the sidewall, wherein the sidewall is formed from a cloth material that includes a camouflage pattern, wherein the cloth material is weather resistant and UV resistant.

18. The method of claim 16, wherein the yard object is located in the interior cavity of the landscaping cover and the inner surface of the sidewall faces an external surface of the yard object when the cover is in use.

19. The method of claim 16, further comprising a fastener coupled to the sidewall, the fastener configured to constrict the inner surface of the sidewall into engagement with the external surface of the yard object such that the cover is secured to the yard object, wherein the fastener includes at least one of a buckle, a strap, a drawstring, and a loop and hook material.

20. A method for concealing an outdoor yard object with a cover comprising:
providing a landscaping cover, the cover comprising:
a top edge;
a bottom edge;
a flexible sidewall extending between the top edge and the bottom edge, the sidewall including an inner surface and an outer surface;
an interior cavity defined by the inner surface of the sidewall, wherein the cover is configured to receive the yard object within the interior cavity; and
an opening to the interior cavity defined by the bottom edge;
placing the cover over the yard object by inserting the yard object through the opening into the interior cavity such that the inner surface of the sidewall contacts an external surface of the yard object;
moving the cover along the length of the yard object to bring the bottom edge of the cover adjacent to a bottom edge of the yard object such that substantially all of the yard object is concealed by the cover; and
fixing the cover in place relative to the yard object.
